(19) United States
(12) Patent Application Publication
(10) Pub. No.: US 2011/0095090 A1
(43) Pub. Date: Apr. 28, 2011

(54) Radio Frequency Indentification Device Molded into a Product Part

(75) Inventors: Mark S. Tracy, Tomball, TX (US); Paul J. Doczy, Cypress, TX (US); Jeffrey A. Lev, Tomball, TX (US)

(73) Assignee: HEWLETT-PACKARD DEVELOPMENT COMPANY L.P, Houston, TX (US)

(21) Appl. No.: 12/994,066

(22) PCT Filed: May 20, 2008
(86) PCT No.: PCT/US2008/064251

§ 371 Date: Nov. 22, 2010

(51) Int. Cl. G06K 19/067; G06K 7/01; B29C 45/14

(52) U.S. Cl. 235/492; 264/275

(57) ABSTRACT

A method and system for molding a radio frequency identification RFID device to a product part. In one embodiment, a method comprising affixing an RFID device to a label, feeding the label into a molding cavity of a molding device, positioning the label within the molding cavity; injecting molten resin into the molding cavity, fusing the molten resin and label into a product part, and ejecting the product part from the molding cavity. In another embodiment, a method comprising affixing an RFID device to a transfer film, rolling the transfer film into a molding cavity of a molding device, positioning the transfer film within the molding cavity, injecting molten resin into the molding cavity, and transferring the RFID device from the transfer film to a product part.

### FIELD OF THE INVENTION

The present invention relates generally to the field of injection molding. More particularly, the present invention relates to molding a radio frequency identification (RFID) device to a product part during an injection molding process.

### BACKGROUND OF THE INVENTION

This section is intended to provide a background or context to the invention that is recited in the claims. The description herein may include concepts that could be pursued, and are not necessarily ones that have been previously conceived or pursued. Therefore, unless otherwise indicated herein, what is described in this section is not prior art to the description and claims in the application and is not admitted to be prior art by inclusion in this section.

The present invention relates generally to the field of RFID. RFID is a technology that is used to automatically identify objects associated with RFID devices. This automatic identification is beneficial because it significantly improves the ability to identify and track objects that have attached RFID devices. Prior to RFID devices there existed, other identification means, such as barcodes, which provided identification of objects. However, RFID devices have been rapidly replacing barcodes and are becoming more prevalent because it has been realized that radio waves enable faster and simpler retrieval of identification data.

In general, RFID devices have been included within a portion of an object's packaging. However, this has been problematic because RFID devices can fall off, be easily removed, switched, or even damaged. Accordingly, there is a need for a simple and effective method of molding the RFID device directly to an object during the manufacturing process and thereby making the RFID device a permanent part of the object.

### SUMMARY OF THE INVENTION

In accordance with an aspect of the invention, there is a system for radio frequency identification (RFID), the system comprising an electronic device, an electronic device enclosure, and an RFID device, wherein the RFID device is molded to a portion of the electronic device enclosure.

In accordance with another aspect of the invention, there is a method of molding a radio frequency identification (RFID) device within a product part, the method comprising affixing an RFID device to a label, feeding the label into a molding cavity of a molding device, positioning the label within the molding cavity. injecting molten resin into the molding cavity, fusing the molten resin and label into a product part, and ejecting the product part from the molding cavity.

In accordance with another aspect of the invention, there is a method affixing a radio frequency identification (RFID) device to a product part, the method comprising affixing an RFID device to a transfer film, rolling the transfer film into a molding cavity of a molding device, positioning the transfer film within the molding cavity, injecting molten resin into the molding cavity, and transferring the RFID device from the transfer film to a product part.

### BRIEF DESCRIPTION OF THE DRAWINGS

FIG. 1 depicts an embodiment of the electronic device comprising an RFID device.

FIG. 2 is a flowchart of an embodiment of an injection molding method in accordance with the present invention.

FIG. 3 is a flowchart of an embodiment of an injection molding method in accordance with the present invention.

### DETAILED DESCRIPTION OF THE PREFERRED EMBODIMENTS

The invention is described below with reference to drawings. These drawings illustrate certain details of specific embodiments that implement the systems and methods of the present invention. However, describing the invention with drawings should not be construed as imposing, on the invention, any limitations that may be present in the drawings. The present invention contemplates both methods and systems.

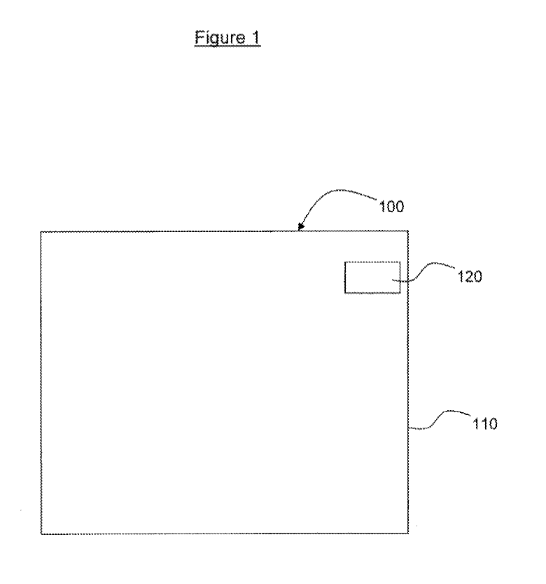

FIG. 1 depicts an exemplary system (100) including an electronic device (110) and an RFID device (120). The electronic device (110) may be in the form of a computer, a laptop, a personal digital assistant (PDA), a telephone, a global positioning system (GPS), a television, a printer, a server, a gaming system, a notebook, a tablet, a camera, a scanner, a calculator, a fax machine, a mouse, or other types of similar electronic devices. The electronic device may include an enclosure, a processing unit, a memory, an RFID device (120), and a system bus that couples various system components including the memory and the processing unit. The RFID device may be electrically coupled to the processing unit or independent and not coupled to the processing unit of the electronic device.

The memory may include read only memory (ROM) and random access memory (RAM). The electronic device may also include a magnetic hard disk drive for reading from and writing to a magnetic hard disk, a magnetic disk drive for reading from or writing to a removable magnetic disk, and an optical disk drive for reading from or writing to removable optical disk such as a DVD-ROM, CD-ROM or other optical media. The drives and their associated computer-readable media provide nonvolatile storage of computer-executable instructions, data structures, program modules, and other data for the computer.

As depicted in FIG. 1, an RFID device (120) is molded to the electronic device (120). More specifically, the RFID (120) device is molded to a product part, such as an electronic device enclosure. The RFID device (120) is a tag or object that may be molded into or onto the electronic device enclosure via methods discussed in greater detail below. Once molded, the RFID device provides identification of the electronic device to other entities via radio waves. Other entities may include inventory tracking devices, GPS tracking devices, and/or telecommunication devices/networks. However, this should not be seen as limiting, since it is contemplated that the RFID device can communicate and provide identification to a plurality of different device types. Depending on the type of RFID device, the radio waves emitted from the RFID device may be read from short distances as well as far distances. Furthermore, the RFID device may include an integrated circuit, an antenna, and a memory. However, the RFID does not necessarily require an integrated circuit, memory, or antenna. The antenna type may be a low frequency type, a high frequency type, an ultra high frequency type, a patch type, a dipole type, or the like. Furthermore, as discussed in greater detail below, the antenna can he created from conductive ink that is transferred during the injection molding process.

With respect to the type of RFID device, it is contemplated that the RFID may be a passive RFID device in one embodiment, an active RFID device in another embodiment, or a semi-passive RFID device in yet another embodiment. However, these three embodiments should not seen as limiting, as other types of RFID devices are also contemplated. If the RFID is a passive RFID, no internal power supply is necessary. The electrical current is induced in the antenna by incoming radio frequency signals and thereby provides sufficient power to enable the passive RFID device to power up and transmit a response. if the RFID device is an active RFID device, the RFID device comprises an internal power source such as, for example, a battery. This internal power source enables the RFID to transmit further distances. Furthermore, the internal power supply helps improve the responsiveness of the RFID device. Alternatively, if the RFID device is a semi-passive RFID device, the RFID comprises an internal power supply (similar to an active RFID). However, the internal power supply does not power the broadcasting of the signal.

Additionally, in one embodiment, the RFID includes built-in firewall access controls, communication encryption, and/or silent mode to help ensure exclusive control of the RFID device. Thus, in this embodiment, the RFID device can he configured to not respond until authorization or validation procedures are conducted and satisfied.

Furthermore, in another embodiment, it is contemplated that the RFID may include a sensor to detect, store, and/or transmit various measurements. For example, the sensor can monitor parameters such as temperature, light, shock, vibration, humidity, radiation, and pressure. These detected parameters can be transmitted to components within the system or to components or entities outside the system. If transmitted within the system, the processor and/or memory of the system may receive the sensor outputs and optionally take subsequent actions based on the sensor outputs. For example, if the sensor detects a high temperature, the processor could execute instructions to place the system in a power savings mode or another type of mode that lowers the internal temperature and thereby reduces the chance of entering into a thermal shutdown or overheat condition. Alternatively, the processor may execute instructions to provide an indication to the user of the electronic device based upon the detected or measured parameters.

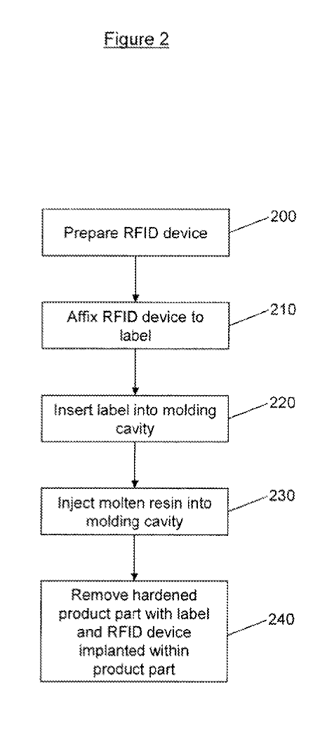

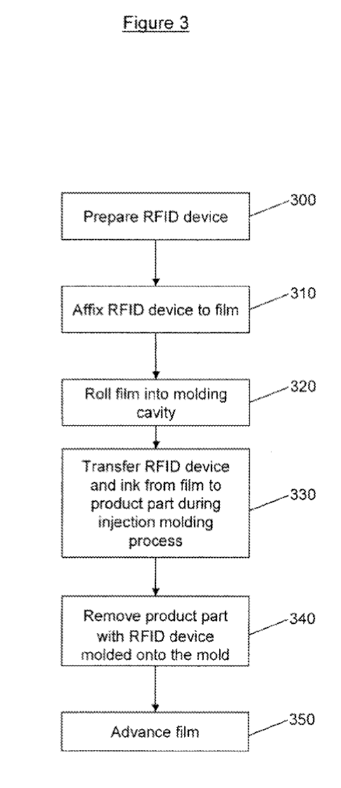

FIG. 2 and FIG. 3 depict exemplary embodiments of methods that may be used to implant or mold the RFID device (120) to a product part, such as an electronic device enclosure. Both embodiments involve injection molding. More particularly, both embodiments involve a type of injection molding referred to as in-mold decoration.

Injection molding is a manufacturing technique for creating various types of products. In the injection molding process, molten plastic or resin is injected at high pressure into a mold, which is the inverse of the product's shape. The molten resin conforms to the geometry of the mold and hardens in the geometric shape of the mold. Once hardened, the mold is opened and product part is removed via ejection pins.

In-mold decoration is a special type of injection molding that adds decorative features during the injection molding process. As one can imagine, production costs may be greatly reduced by combining the molding process and the decoration processes into one single process. Moreover, production output may be increased by reducing the time spent manufacturing each individual product part. As described in greater detail below, the present invention contemplates the inventive concept of implanting or fusing an RFID device within a product part during the in-mold decoration process.

FIG. 2 depicts a first embodiment that may be used to implant the RFID device into a product part, wherein the product part may be an electronic device enclosure. This method is referred to as in-mold labeling (IML). In general, IML is a technology that involves inserting a thin label into a molding cavity and overlaying the label with a resin or plastic during the injection molding process. The label may be a decorative label that may include one or more graphics, designs, drawings, effects, grains, patterns, colors, or other representations. Therefore, by implanting or molding the decorative label to the molded product part during the injection molding process, a product part with a unique decorative expression is created.

The inventive method of molding an RFID device via IML will now be described with reference to FIG. 2. Block 200 comprises the operation of preparing the RFID device for the injection molding process. This preparation may include processes such as changing the encapsulate material of the RFID device to enable the RFID device to withstand the injection molding process or to ensure that no deformation occurs during the injection molding process. Moreover, the encapsulate material of the RFID device may be modified based on molding parameters or based on the type and/or location of the RFID device with respect to the electronic device enclosure. Furthermore, and as discussed in greater detail below, the RFID device may be pre-programmed or otherwise configured prior to the injection molding process.

Block 210 comprises the operation of affixing the RFID device to a label, wherein the label may be comprised of film or paper. The RFID device may be affixed to the label via adhesive, tape, fasteners, pressure, and the like. If the label is comprised of paper, one or more top coating layers may be required to protect the porous material from moisture and rough handling. Furthermore, the paper may be a synthetic paper type and therefore not comprise wood fibers. The use of synthetic paper may be beneficial since it can be formulated to be especially receptive to commercial printing inks and therefore provide crisp, high-quality graphics. The RFID device may be affixed directly to the paper or, alternatively, the RFID device may be affixed to any of the one or more top coating layers that may be provided on the paper.

Alternatively, the label may comprise film. The type of film may include one of transparent film, laminated film, polypropylene film, polycarbonate film, polystyrene film, or a combination thereof. The use of film may provide benefits such as durability and seamlessness. With regard to laminated film, this type of film includes a first printed surface layer protected by a second layer of film to provide high wear-resistance. Other types of film may be similarly layered. In cases where the film comprises multiple layers, it is contemplated that the RFID device may be affixed to any one of the film layers via the affixing techniques discussed above.

Once the RFID device is affixed to the label, block 220 comprises the operation of inserting the label into a molding cavity within an injection molding device. The molding cavity is generally an inverse mold of the desired final product part. Note that the labels described above can either be provided via rolls or sheets. Once the label (with the affixed RFID device) is located within the molding cavity of the injection molding device, block 230 comprises the operation wherein the molten resin is injected into the molding cavity. The label fuses with the molten resin and thereby creates a molded product part with an incorporated label. In one embodiment, the molten plastic is a clear substrate, such as polycarbonate or acrylic. In another embodiment, the molten plastic is a scratch proof material. However, these types of plastic and resins should not be considered as limiting, as it is expressly contemplated that any commonly used IML resin or plastic may be injected in the molding cavity. Once the injection molding operation is complete, block 240 comprises the operation wherein the molded product part is removed from the molding cavity. The final product is a product part with an RFID device and label implanted within the product part.

FIG. 3 depicts a second embodiment of a method that may be used to affix an RFID device (120) to an electronic device (110). This method involves another type of in-mold decoration referred to as in-mold roll (IMR). In general, IMR is a technology that involves transferring ink from a film (transfer foil or carrier foil) to a mold during an injection molding process. Similar to IML, the film may he a decorative film that may include one or more graphics, designs, drawings, effects, grains, patterns, colors, or other representations. However, unlike IML, IMR does not actually implant a label within a mold. Instead, ink from a film is transferred onto a surface of a mold during the injection molding process.

In the IMR process, a transfer film, such as carrier film or transfer foil, carriers a layer of dried paint or ink, wherein the paint or ink is arranged in a decorative pattern or a desired design. In one embodiment, the ink may be conducive. As such, the conducive ink can function as or be used as an antenna for the RFID device and thereby reduce production and material costs. The transfer film also includes a release layer that enables the design to release from the transfer film and transfer to the mold during the injection molding process. Therefore, upon completion of the IMR injection molding process, a final product is created with a unique decorative expression. As described in detail below, the present invention contemplates the inventive concept of transferring an RFID device to a product during the IMR process.

The inventive method of molding an RFID device via IMR will now be described with reference to FIG. 3. Block 300 comprises the operation of preparing the RFID for the injection molding process. This preparation may include changing the encapsulate material of the RFID device to enable the RFID device to withstand the injection molding process and to ensure that no deformation occurs during the injection molding process. Moreover, the encapsulate material may be modified based on molding parameters and based on the type and/or location of the RFID device with respect to the product mold. Furthermore, and as discussed in greater detail below, the RFID device may be pre-programmed or otherwise configured prior to the injection molding process.

Block 310 comprises the operation of affixing the RFID device to the film. The RFID may be affixed to the transfer film via adhesive, tape, fasteners, pressure, and the like. Furthermore, the RFID device may be pressed into the ink or paint and thereby affix to the transfer film. Once affixed to the film, block 320 comprises the operation of rolling or advancing the transfer film into a molding cavity within an injection molding device. The molding cavity is generally an inverse of the shape of the desired final product part. Note that IMR may involve a roll of film that is rolled a specific amount for each iteration of the injection molding process. Once the film with the affixed RFID device is located within the molding cavity of the injection molding device, block 330 comprises the operation of injecting the molding cavity with molten resin or plastic and thereby transferring the RFID and ink from the transfer film to the molded product part. Upon completion of the injection molding, block 340 comprises the operation of removing the resulting molded product part. Once the product part is removed, block 350 comprises the operation of advancing the roll and positioning the roll for the next area to be IMR transferred.

With either IML or IMR, the molding location of the RIFD device is dependent upon the type of the electronic device. In one embodiment, the RFID device is molded in the position that provides for optimum radio frequency reception and transmission. For example, the RFID device may be molded to the location that provides the an optimal Effective Radiate Power (ERP) level or Received Signal Strength Indication (RSSI). Furthermore, the RFID device may be molded based on considering the probability of colliding with other protocols. In one embodiment, wherein the electronic device is a laptop computer, the RFID device is molded proximal or within to the liquid crystal display enclosure of a laptop computer.

Once the RFID device has been molded to the electronic device, various benefits can be realized. For example, one embodiment contemplates using RFIDs to configure products to order. Accordingly, precise customer data, configuration data, routing data, and/or design data may be programmed into the RFID device associated with the electronic device for detection during the various phases of manufacturing and shipping. Thus, inaccuracies with respect to the customer's configuration desires may be minimized. For example, a customer may request a particular processor, memory, and external design. This information may be programmed into the RFID device. Accordingly, at any point during manufacturing the customer's product, the information may be detected and confirmed to assure that the product is being manufactured in accordance with the customer's desires. Moreover, customer contact and shipping information can be programmed into the RFID device associated with the electronic device. The programming could be done prior to the molding process or subsequent to the molding process. Therefore, errors in shipping destination and misrouting can also be minimized. Accordingly, supply chain management can be greatly improved by providing the ability to accurately identify, track, and manage the movement of the products with the molded MID devices.

The foregoing description of embodiments of the present invention have been presented for purposes of illustration and description. It is not intended to be exhaustive or to limit the present invention to the precise form disclosed, and modifications and variation are possible in light of the above teachings or may be acquired from practice of the present invention. The embodiments were chosen and described in order to explain the principles of the present invention and its practical application to enable one skilled in the art to utilize the present invention in various embodiments and with various modification as are suited to the particular use contemplated.

What is claimed is:

1. A system (100) for radio frequency identification (RFID), the system comprising:
an electronic device (110);
an electronic device enclosure; and
an RFID device (120);
wherein the RFID device is molded to a portion of the electronic device enclosure.

2. The system of claim 1, wherein the RFID (120) device is affixed to a label and the label is molded within the electronic device enclosure.

3. The system of claim 2, wherein the label comprises paper or film and the label also comprises a decorative design disposed on the label.

4. The system of claim 3, wherein the label comprises a plurality of layers and the RFID device (120) is located within one of the plurality of layers.

5. The system of claim 1, wherein the RFID device (120) is molded onto a surface of the electronic device enclosure.

6. The system of claim 5, wherein the surface of the electronic device enclosure comprises conductive ink that acts as an antenna for the RFID device (120).

7. The system of claim 1, wherein the RFID device (120) includes a sensor for measuring quantities selected from a group consisting of temperature, shock, vibration, humidity, radiation, and pressure.

8. The system of claim 1, Wherein the RFID device (120) is configured to store customer data, configuration data, routing data, or design data.

9. The system of claim 1, wherein the electronic device (110) is one of a group consisting of a computer, a PDA, a telephone, a GPS unit, a television, a printer, a server, a gaming system, a notebook, a tablet, a camera, a scanner, a calculator, and a fax machine.

10. The system of claim 1, wherein the RFID device (120) is molded proximal to a liquid crystal display enclosure of a portable computing device.

11. A method of molding a radio frequency identification (RFID) device within a product part, the method comprising:
affixing an RFID device (120) to a label;
feeding the label into a molding cavity of a molding device;
positioning the label within the molding cavity;
injecting molten resin into the molding cavity;
fusing the molten resin and label into a product part; and
ejecting the product part from the molding cavity.

12. The method of claim 11, wherein the label includes one or more layers and the RFID is affixed to any one of the one or more layers.

13. The method of claim 11, wherein the label comprises paper or film.

14. The method of claim 11, wherein the RFID device (120) includes a sensor for measuring quantities selected from a group consisting of temperature, shock, vibration, humidity, radiation, and pressure.

15. The method of claim 11, wherein the label is molded within a liquid crystal display enclosure product part.

16. A method of affixing a radio frequency identification (RFID) device to a product part, the method comprising:
affixing an MID device (120) to a transfer film;
rolling the transfer film into a molding cavity of a molding device;
positioning the transfer film within the molding cavity;
injecting molten resin into the molding cavity; and
transferring the RFID device from the transfer film to a product part.

17. The method of claim 16, wherein the transfer film comprises conductive ink.

18. The method of claim 17, wherein the RFID device and the conductive ink are transferred to the product part.

19. The method of claim 18, wherein product part is a liquid crystal display enclosure of an electronic device (110).

20. The method of claim 16, wherein the RFID device (120) includes a sensor for measuring quantities selected from a group consisting of temperature, shock, vibration, humidity, radiation, and pressure.
